(19) United States
(12) Patent Application Publication
(10) Pub. No.: US 2026/0228006 A1
(43) Pub. Date: Aug. 6, 2026

(54) FETCH SKIPPING

(71) Applicant: Arm Limited, Cambridge (GB)

(72) Inventor: Kim Richard SCHUTTENBERG, Gilbert, AZ (US)

(21) Appl. No.: 19/046,712

(22) Filed: Feb. 6, 2025

(51) Int. Cl. G06F 9/30; G06F 9/32

(52) U.S. Cl. CPC G06F 9/30069; G06F 9/30058; G06F 9/321

(57) ABSTRACT

An apparatus includes no-op-compatible instruction tracking circuitry configured to store tracking information indicative of program counter addresses corresponding to no-op-compatible instructions architecturally permitted to be treated as a no-op instruction; and fetch skipping circuitry configured to determine, depending on whether a given fetch target address is identified as corresponding to a no-op-compatible instruction by the tracking information stored by the no-op-compatible instruction tracking circuitry, whether to skip fetching of a given instruction corresponding to the given fetch target address.

### BACKGROUND

### Technical Field

The present technique relates to the field of data processing.

### Technical Background

A data processing apparatus may include a processing pipeline having a number of pipeline stages. These may include a fetch stage for fetching instructions from an instruction cache, a decode stage for decoding the fetched instructions, and a processing stage for processing the decoded instructions.

### SUMMARY

At least some examples of the present technique provide an apparatus comprising: no-op-compatible instruction tracking circuitry configured to store tracking information indicative of program counter addresses corresponding to no-op-compatible instructions architecturally permitted to be treated as a no-op instruction; and fetch skipping circuitry configured to determine, depending on whether a given fetch target address is identified as corresponding to a no-op-compatible instruction by the tracking information stored by the no-op-compatible instruction tracking circuitry, whether to skip fetching of a given instruction corresponding to the given fetch target address.

At least some examples of the present technique provide a system comprising:
the apparatus described above, implemented in at least one packaged chip;
at least one system component; and
a board,
wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a non-transitory computer-readable medium storing computer-readable code for fabrication of an apparatus comprising: no-op-compatible instruction tracking circuitry configured to store tracking information indicative of program counter addresses corresponding to no-op-compatible instructions architecturally permitted to be treated as a no-op instruction; and fetch skipping circuitry configured to determine, depending on whether a given fetch target address is identified as corresponding to a no-op-compatible instruction by the tracking information stored by the no-op-compatible instruction tracking circuitry, whether to skip fetching of a given instruction corresponding to the given fetch target address.

At least some examples of the present technique provide a method comprising: storing tracking information indicative of program counter addresses corresponding to no-op-compatible instructions architecturally permitted to be treated as a no-op instruction; and determining, depending on whether a given fetch target address is identified as corresponding to a no-op-compatible instruction by the tracking information stored by the no-op-compatible instruction tracking circuitry, whether to skip fetching of a given instruction corresponding to the given fetch target address.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example processing pipeline according to the present techniques;

FIG. 2 illustrates steps for determining whether to skip fetching of a given instruction;

FIG. 3 illustrates an example of the no-op-compatible instruction tracking circuitry structure for storing tracking entries;

FIG. 4 illustrates an example data processing apparatus according to the present techniques;

FIG. 5 illustrates an example of the no-op-compatible instruction tracking circuitry for storing tracking entries;

FIG. 6 illustrates steps for allocating a new tracking entry in the NOP-compatible instruction tracking circuitry for a NOP-compatible instruction starting at a branch target address of a taken branch predicted by a branch predictor;

FIG. 7 shows steps for allocating a new tracking entry in the NOP-compatible instruction tracking circuitry for a NOP-compatible instruction starting at a branch target address of a taken backwards branch predicted by a branch predictor;

FIG. 8 illustrates steps for skipping fetching of NOP-compatible instructions that are at a branch target of a taken branch based on performing a lookup of NOP-compatible instruction tracking circuitry;

FIG. 9 illustrates steps for clearing tracking information from the NOP-compatible instruction tracking circuitry 50 in response to a hint information clearing event;

FIG. 10 illustrates an example program flow including a branch future instruction;

FIG. 11 illustrates an example program flow including a branch to a branch target identifier instruction;

FIG. 12 illustrates an example program flow including a preload instruction;

FIG. 13 illustrates an example program flow including a nested function call; and

FIG. 14 illustrates a system and a chip-containing product.

### DESCRIPTION OF EXAMPLES

In accordance with some example embodiments, there is provided an apparatus comprising no-op-compatible instruction tracking circuitry configured to store tracking information indicative of program counter addresses corresponding to no-op-compatible instructions architecturally permitted to be treated as a no-op instruction.

As referred to herein, a no-op instruction, or NOP instruction, is an instruction that leaves architectural register state and memory unchanged. It will be appreciated that some NOP instructions can still cause some changes in processor state, such as diagnostic information, e.g. trace data or performance monitor counters.

According to the present example embodiment, the apparatus also comprises fetch skipping circuitry configured to determine, depending on whether a given fetch target address is identified as corresponding to a no-op-compatible instruction by the tracking information stored by the no-op-compatible instruction tracking circuitry, whether to skip fetching of a given instruction corresponding to the given fetch target address.

Hence, a determination can be made as to whether to skip fetching of a given instruction based on whether the corresponding fetch target address is identified as corresponding to a no-op-compatible instruction. Such a no-op-compatible instruction is architecturally permitted to be treated as a no-op instruction, and so fetching of this instruction may be skipped because the instruction does not have an effect on the architectural state. As discussed further herein, some instruction types, such as hint instructions, may be treated as NOP instructions once they have been executed a first time and before a context switch occurs. Further, some types of instructions, in a given implementation, may be treated as NOP instructions but in other implementations may not be treated as NOP instructions. In cases such as theses where a given instruction is architecturally permitted to be treated as a NOP instruction, the fetching of the given instruction can be avoided. Hence, the amount of fetch bandwidth that is used unnecessarily to fetch NOP instructions (or instructions that act like NOP instructions) is reduced, thereby increasing fetch bandwidth. This also increases the amount of fetch bandwidth available for fetching other instructions (that are not treated as NOP instructions) and hence improves processor performance. This can also be useful for lightweight implementations where fetch bandwidth is limited.

In some examples, the apparatus comprises performance monitoring circuitry configured to maintain an instruction counter indicative of a count of a number of executed instructions; wherein, in a case where fetching of the given instruction is skipped based on the tracking information stored by the no-op-compatible instruction tracking circuitry, the performance monitoring circuitry is configured to update the instruction counter as if the given instruction is fetched and executed, even though the given instruction is not fetched and executed. Hence, accurate performance monitoring counters and trace counters can be maintained even in the event that fetching of a given instruction is skipped.

In some examples, the tracking information comprises one or more tracking entries, where a given tracking entry is indicative of a start program counter address representing a start of a run of one or more no-op-compatible instructions. Hence, no-op-compatible instructions can be efficiently tracked and the fetching of them skipped.

In some examples, the given tracking entry is indicative of a next fetch address corresponding to a next instruction occurring after the run of one or more no-op-compatible instructions. Hence, the next address of the next instruction to fetch after the run of one or more skipped instructions can be efficiently determined. This reduces a delay between skipping the fetching of an instruction and fetching the subsequent non-skipped instruction. The way in which the given tracking entry is indicative of a next fetch address is not particularly limited. For example, the next fetch address may be indicated as an absolute address, as an offset relative to a start program counter of the run of no-op-compatible instructions, or (if a fixed-length instruction set is used), as a count of the number of no-op-compatible instructions in the run. The disclosure is not particularly limited in this respect.

In some examples, in response to the given fetch target address being detected as corresponding to the start program counter address of a corresponding tracking entry of the one or more tracking entries, the fetch skipping circuitry is configured to: skip fetching of the run of one or more no-op-compatible instructions starting from the start program counter address; and resume instruction fetch from the next fetch address indicated by the corresponding tracking entry. In this way, the fetching of no-op-compatible instructions may be efficiently skipped and the instruction fetching restarted. Further, in the case that a run of a plurality of no-compatible instructions is present, the entire run of no-op-compatible instructions may be skipped based on a given tracking entry, thereby reducing the number of tracking entries required to skip the fetching of a plurality of no-op-compatible instructions.

In some examples, the given tracking entry specifies a count indication indicative of a number of no-op-compatible instructions in the run of one or more no-op compatible instructions. In variable-length instruction set implementations, the next fetch address (offset) can be specified separately from the instruction count. The fetch address indication may be used for fetch control and the count may be used for PMU (performance monitoring unit) updates, and with variable length instructions these cannot be deduced from the other. In fixed-length instruction set implementations, the count and next fetch address can be indicated by a single parameter (either as an absolute address, relative address/size of the no-op-compatible instruction block or as a count of the number of instructions), as any of these enables both the next fetch address and number of instructions to be deduced.

In some examples, the apparatus comprises performance monitoring circuitry configured to maintain an instruction counter indicative of a count of a number of executed instructions; wherein in response to the given fetch target being detected as corresponding to the start program counter address of a corresponding tracking entry of the one or more tracking entries, the performance monitoring circuitry is configured to increment the instruction counter by the number of no-op-compatible instructions indicated by the count indication. Hence, the instruction counter may be efficiently updated and accurately maintained.

In some examples, in response to detecting, based on instruction decoding, a run of one or more no-op-compatible instructions starting at a branch target address of a taken branch instruction, the no-op-compatible instruction tracking circuitry is configured to allocate a new tracking entry to specify, as the start program counter address, the branch target address of the taken branch instruction.

Hence, a new tracking entry, based on instruction decoding, may be allocated that specifies a branch target address of a taken branch instruction as the start program counter address. The present inventors have identified that no-op-compatible instructions may typically be placed at a branch target of a branch, and so it can be useful to allocate new tracking entries corresponding to the branch target address.

In some examples, allocation into the tracking structure occurs in response to taken branches to a branch target where a run of one or more no-op-compatible instructions are detected, but does not occur when a no-op-compatible instruction is detected at an address which is not the target of a taken branch.

The likelihood of the presence of no-op-compatible instructions is higher at the start of a basic block (for example compared to part way through a basic block), so limiting allocations to the no-op-compatible instruction tracking circuitry to a run of one or more no-op-compatible instructions starting at a branch target address of a taken branch instruction provides less power cost for a given amount of performance uplift. Indeed, by specifying as the start program counter address the branch target address of a taken branch instruction, a run of one or more no-op-compatible instructions can be efficiently tracked and the fetching of them skipped.

In some examples, the fetch skipping circuitry is configured to trigger a lookup of the no-op-compatible instruction tracking circuitry for the given fetch target address in response to detecting that the given fetch target address corresponds to a branch target address of a taken branch, to determine whether the given fetch target address corresponds to a run of one or more no-op-compatible instructions. In these examples, the taken branch is detected at prediction time, not execution time—i.e. detecting a branch being predicted to be taken to the given branch target address. As discussed above, the likelihood of the presence of no-op-compatible instructions is higher at the start of a basic block (for example compared to part way through a basic block), so triggering a lookup of the no-op-compatible instruction tracking circuitry when the given fetch address corresponds to a branch target address provides less power cost for a given amount of performance uplift.

An example of a no-op-compatible instruction that may occur after a branch is a hint instruction (which has already been executed once). A hint instruction provides a performance hint that if omitted would not change architectural results of a program comprising that instruction. Once a hint instruction has been processed (and a context switch has not yet happened), it may not be required to execute the hint instruction again. In this case, once the hint instruction has been processed a first time, it effectively becomes a NOP instruction. Hence, it may be useful to avoid fetching these hint instructions once they are effectively NOP instructions. Hint instructions may represent a relatively large class of instructions, and so skipping the fetching of these instructions when they are effectively NOP instructions can be useful for increasing fetch bandwidth.

In some examples, in response to detecting, based on instruction decoding, a run of one or more no-op-compatible instructions starting at a branch target address of a taken backwards branch instruction, the no-op-compatible instruction tracking circuitry is configured to allocate a new tracking entry to specify, as the start program counter address, the branch target address of the taken backwards branch operation. A backwards branch instruction is a branch instruction for which the target address is less than the program counter (PC) address of the branch instruction.

In some examples, allocation into the tracking structure occurs in response to taken backwards branches to a branch target where a run of one or more no-op-compatible instructions are detected, but does not occur in response to a taken forwards branch even if the forward branch has a run of one or more no-op-compatible instructions starting at the branch target of the forwards branch.

Backwards branches may be typically used in loops to branch back to the start of a loop. So focusing on no-op-compatible instructions that follow backwards branches will be more likely to identify the no-op-compatible instructions that would occur repeatedly in multiple iterations of a loop, and so this represents a significant opportunity for reducing wasted fetch bandwidth. Thus, focusing allocations to/lookups in the no-op-compatible instruction tracking structure on branch targets of backwards branches helps give further energy efficiency improvements for a given level of performance uplift. In particular, the tracking entries that may provide the most benefit are those that suppress the fetching of no-op-compatible instructions that follow a backwards branch. Thus, to reduce the overhead of the no-op-compatible instruction tracking circuitry, the tracking entries may be set in this case and not in others. This reduces the likelihood that no-op-compatible instruction tracking circuitry storage capacity is used for tracking entries corresponding to no-op-compatible instructions that occur once or relatively infrequently.

An example of a no-op-compatible instruction that may occur at the start of a loop is a hint instruction (which has already been executed once). A hint instruction in a loop may provide information about upcoming memory accesses that are inside the loop, for example. The architectural state for such memory accesses is not preserved on a context switch, and so hint instructions may typically be placed inside a loop at the start. Once a hint instruction has been processed (and a context switch has not yet happened), it may not be required to execute the hint instruction again. In this case, once the hint instruction has been processed a first time, it effectively becomes a NOP instruction on later iterations of the loop. Hence, it may be useful to avoid fetching these hint instructions on later iterations of the loop.

In some examples, the fetch skipping circuitry is configured to trigger a lookup of the no-op-compatible instruction tracking circuitry for the given fetch target address in response to detecting that the given fetch target address corresponds to a branch target address of a taken backwards branch, to determine whether the given fetch target address corresponds to a run of one or more no-op-compatible instructions. Hence, the lookup may be triggered automatically based on the presence of taken backwards branch. As mentioned previously, backwards branches are often found in loops and so efficiency improvements can be realized by identifying and skipping no-op-compatible instructions that would otherwise occur repeatedly in multiple iterations of a loop.

In some examples, the given tracking entry specifies a no-op-compatible instruction type associated with at least one of the run of one or more no-op-compatible instructions. It will be appreciated that this is not essential. For some no-op-compatible instructions, the type doesn't matter—e.g. if the instruction simply isn't supported in a given implementation. For others, it might be that it is useful to record the instruction type, e.g. for a BTI instruction (branch target identifier that indicates a permitted branch target—certain branches may cause a fault if the instruction at the target address isn't a BTI instruction), it may be useful to record that this is a permitted branch target, but skip/elide the fetching of the BTI instruction itself. Hence, by recording the no-op-compatible instruction type such mechanisms are still supported while being able to skip the fetching of the instruction.

In some examples, the given fetch target address corresponds to a branch target address. In some examples, the given fetch target address corresponds to a branch PC (e.g. a PC address of a branch instruction).

In some examples, the fetch skipping circuitry is configured to trigger a look up of the no-op compatible instruction tracking circuitry for the given fetch target address and when the given fetch target address is determined to correspond to a branch target address, use the lookup of the no-op compatible instruction tracking circuitry to determine whether the given fetch target address corresponds to a run of no-op compatible instructions. Hence, in some examples, rather than looking up the no-op compatible instruction tracking circuitry in response to detecting that the given fetch target address corresponds to a branch target address, looking up of the no-op compatible instruction tracking circuitry and determining that the given fetch target address corresponds to a branch target address may be performed in parallel based on a branch PC. For example, a look up of a branch prediction structure for a given branch PC may be triggered to determine a branch target address, and a look up of the no-op compatible instruction tracking circuitry for the branch PC may be triggered to determine an indication of whether the branch target address corresponds to a run of one or more no-op compatible instructions.

In some examples, the apparatus comprises processing circuitry configured to execute instructions defined by an instruction set architecture, the instruction set architecture defining a plurality of no-op-compatible instruction types; and the no-op-compatible instruction tracking circuitry is configured to allocate the tracking information in response to detecting presence of a no-op-compatible instruction from a fetch-skip-supported subset of the plurality of no-op-compatible instruction types. It will be appreciated that not all types of no-op-compatible instructions in an instruction set architecture need to be in the fetch-skip-supported subset of instruction types—e.g. some no-op-compatible instructions may be implemented on a given processor implementation and only act as NOP instructions on other implementations.

In some examples, the fetch-skip-supported subset comprises at least one no-op-compatible instruction type which is unsupported by the processing circuitry.

In some examples, the fetch-skip-supported subset comprises at least one no-op-compatible instruction type which is supported by the processing circuitry, but which once executed a first time is redundant if executed a second time without an intervening hint information clearing event occurring between the first time and the second time. Such a no-op-compatible instruction may be a hint instruction. The intervening hint information clearing event may be a context switch, an interrupt or an explicit instruction for clearing hints (such as an instruction sync barrier).

In some examples, the no-op-compatible instruction tracking circuitry is configured to clear the tracking information in response to the hint information clearing event. Thus, tracking information that is no longer relevant may be cleared and the fetching of a subsequent hint instruction following a hint information clearing event is not skipped so that the hint information from the subsequent hint instruction can be processed.

In some examples, the fetch-skip-supported subset comprises at least one no-op-compatible instruction type which provides a performance hint that if omitted would not change architectural results of a program comprising that instruction. In some examples, the fetch-skip-supported subset comprises a branch future instruction providing advance warning of a future branch operation. In some examples, the fetch-skip-supported subset comprises a preload instruction providing advance warning of a future load of data for a given address. In some examples, the fetch-skip-supported subset comprises an instruction for calculating or authenticating an authentication code associated with a corresponding data value. In some examples, the fetch-skip-supported subset comprises a branch target instruction representing a legitimate branch target allowed to be a target of a taken branch instruction. In some implementations, if branch target checks are enabled, a fault is signaled if the first instruction at the branch target is not BTI. Hence, the no-op-compatible instruction described herein is not particularly limited and may take various forms.

Specific examples are now explained with reference to the drawings. In the below and the drawings, NOP-compatible instruction tracking circuitry is used interchangeably with no-op-compatible instruction tracking circuitry, and NOP-compatible is used interchangeably with no-op-compatible.

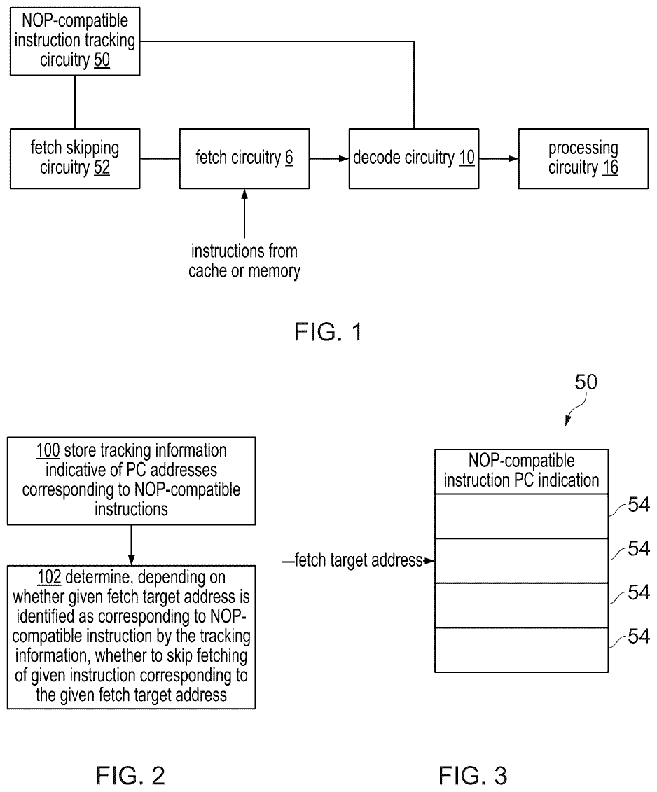

FIG. 1 shows an example processing pipeline which comprises processing circuitry 16 for performing data processing operations in response to instructions decoded by decode circuitry 10. The instructions decoded by the decode circuitry 10 are fetched from a cache or memory (not shown) by fetch circuitry 6.

FIG. 1 also shows NOP-compatible instruction tracking circuitry 50, which is configured to store tracking information indicative of program counter addresses corresponding to no-op-compatible instructions architecturally permitted to be treated as a no-op instruction. Also shown is fetch skipping circuitry 52 which is configured to determine, depending on whether a given fetch target address is identified as corresponding to a no-op-compatible instruction by the tracking information stored by the no-op-compatible instruction tracking circuitry, whether to skip fetching of a given instruction corresponding to the given fetch target address. As a result of this determination, the fetch circuitry 6 may be caused to skip fetching of a given instruction that would be treated as a NOP instruction if it were to be processed by the processing circuitry 16. By skipping the fetching of such instructions, unnecessary utilization of the fetch bandwidth of the fetch circuitry 6 can be reduced.

It will be appreciated that FIG. 1 is a simplified example of a processing pipeline and that the processing pipeline may include many other elements not shown in FIG. 1 for conciseness.

FIG. 2 illustrates a sequence of steps for determining whether to skip fetching of a given instruction. At step 100, tracking information indicative of PC addresses corresponding to NOP-compatible instructions are stored. At step 102, it is determined, depending on whether a given fetch target address is identified as corresponding to a NOP-compatible instruction by the tracking information, whether to skip fetching of a given instruction corresponding to the given fetch target address.

In this way, the fetching of instructions which are architecturally permitted to be treated as NOP instructions (and thus have no architectural effect) can be avoided, thereby increasing fetch bandwidth.

FIG. 3 illustrates an example of the NOP-compatible instruction tracking circuitry 50 for storing tracking information indicative of NOP-compatible instruction program counter indications. For example, the tracking information comprises one or more tracking entries 54. Each tracking entry 54 is indicative of a start program counter address representing a start of a run of one or more no-op compatible instructions.

As shown in FIG. 3, a fetch target address may be compared to the tracking entries 54 to determine whether the fetch target address corresponds to a NOP-compatible instruction and thus that fetching of the instruction corresponding to the fetch target address is to be skipped.

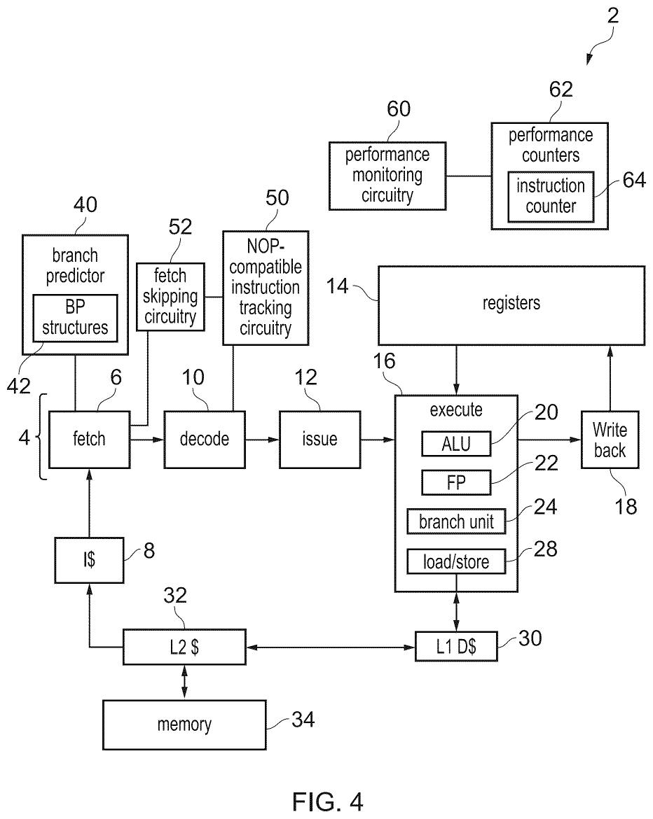

FIG. 4 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. Fetch stage 6, decode stage 10 and execute stage 16 may correspond to fetch circuitry 6, decode circuitry 10 and processing circuitry 16 of FIG. 1 respectively. It will be appreciated that this is merely one example of possible pipeline architecture, and other systems may have additional stages or a different configuration of stages. For example, in an out-of-order processor a register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 26 for performing load/store operations to access data in a memory system 8, 30, 32, 34.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness.

As shown in FIG. 4, the apparatus 2 includes a branch predictor 40 for predicting outcomes of branch instructions. The branch predictor is looked up based on addresses of instructions provided by the fetch stage 6 and provides a prediction on whether those instructions are predicted to include branch instructions, and for any predicted branch instructions, a prediction of their branch properties such as a branch type, branch target address and branch direction (predicted branch outcome, indicating whether the branch is predicted to be taken or not taken). The branch predictor 40 includes BP structures 42 (e.g. a branch target buffer (BTB) for predicting properties of the branches other than branch direction and/or a branch direction predictor (BDP) for predicting the not taken/taken outcome (branch direction)). It will be appreciated that the branch predictor could also include other prediction structures such as a call-return stack for predicting return addresses of function calls, a loop direction predictor for predicting when a loop controlling instruction will terminate a loop, or other more specialised types of branch prediction structures for predicting behaviour of outcomes in specific scenarios.

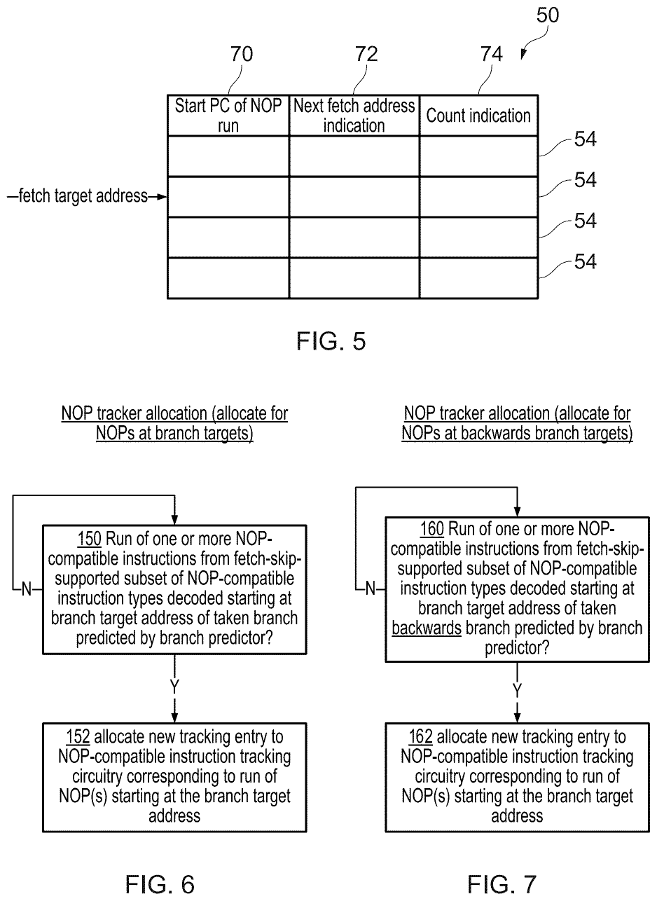

Apparatus 2 also includes fetch skipping circuitry 52 and NOP-compatible instruction tracking circuitry 50 as discussed above in relation to FIG. 1. In response to a given fetch target address being detected as corresponding to the start program counter address of a corresponding tracking entry of the one or more tracking entries, the fetch skipping circuitry 52 may cause the fetch stage 6 to skip fetching of the given instruction corresponding to the given fetch target address. Further, the fetch skipping circuitry 52 may cause the fetch stage 6 to resume instruction fetch from the next fetch address indicated by the corresponding tracking entry (as discussed in relation to FIG. 5).

In some examples, the branch predictor 40 may control the fetch stage 6 to tag instructions identified as being at the target of a taken (backwards) branch, and this tag prompts the decode stage 10 to allocate an entry in the NOP-compatible instruction tracking circuitry 50 if the decoded instruction having the “branch target” tag is found to be a NOP-compatible instruction (or start of a run of NOP-compatible instructions.

In some examples, the NOP-compatible instruction tracking circuitry 50 is a cache for storing the tracking information.

In some examples, the NOP-compatible instruction tracking circuitry 50 may be stored in a BP structure 42 of the branch predictor 40. For example, the NOP-compatible instruction tracking circuitry 50 may be included as part of a branch target buffer (BTB). For example, a BTB may be extended to include the tracking entries described herein. In some examples, the BTB may be extended to include a field indicating that, for a given branch target address, the number of next instructions for which fetching is to be skipped (or the address of the next instruction which is not be skipped).

In other examples, the NOP-compatible instruction tracking circuitry 50 may be looked up in parallel with the BP structures 42. The present teachings are not particularly limited in this respect.

Data processing apparatus 2 also includes performance monitoring circuitry 60, performance counters 62 and instruction counter 64. These may be omitted in some examples.

Performance monitoring circuitry 60 is configured to maintain one or more performance counters 62, such as instruction counter 64 which is indicative of a count of a number of executed instructions. In a case where fetching of the given instruction is skipped based on the tracking information stored by the no-op-compatible instruction tracking circuitry 50, the performance monitoring circuitry 60 is configured to update the instruction counter 64 as if the given instruction is fetched and executed, even though the given instruction is not fetched and executed. The performance monitoring circuitry 60 is also configured to, in response to the given fetch target being detected as corresponding to the start program counter address of a corresponding tracking entry of the one or more tracking entries, increment the instruction counter by the number of no-op-compatible instructions indicated by the count indication. This can ensure that the instruction counter remains accurate even in the case that the fetching of one or more instructions is skipped.

FIG. 5 shows example tracking information that may be stored by the no-op-compatible instruction tracking circuitry 50. Like FIG. 3, FIG. 5 shows a plurality of tracking entries 54. In this example, each tracking entry 54 is indicative of (in some examples includes) a start program counter address representing a start of a run of one or more no-op-compatible instructions, a next fetch address corresponding to a next instruction occurring after the run of one or more no-op-compatible instructions, and a count indication indicative of a number of no-op-compatible instructions in the run of one or more no-op compatible instructions.

Hence, using a given tracking entry 54, the starting PC of a NOP-compatible instruction run, the next fetch address to resume fetching from after skipping, and the number of NOP-compatible instructions in the run can be identified efficiently, and used to efficiently skip fetching of the run and update an instruction counter.

FIG. 6 shows steps for allocating a new tracking entry in the NOP-compatible instruction tracking circuitry 50 (NOP tracker) for a NOP-compatible instruction starting at a branch target address of a taken branch predicted by a branch predictor (such as branch predictor 40 of FIG. 4). At step 105, it is determined whether a run of one or more NOP-compatible instructions from a fetch-skip-supported subset of NOP-compatible instruction types decoded starting at a branch target address of a taken branch is predicted by a branch predictor. If no, then step 150 is repeated for a subsequent run of one or more NOP-compatible instructions. If yes, then the process continues to step 152. At step 152, a new tracking entry is allocated to the NOP-compatible instruction tracking circuitry corresponding to the run of NOP(s) starting at the branch target address. With reference to FIG. 4, the decode stage 10 may in some examples allocate the new tracking entry in the NOP-compatible instruction tracking circuitry 50 having determined that a decoded run of one or more NOP-compatible instructions from a fetch-skip-supported subset of NOP-compatible instruction types starting at a branch target address of a taken branch is predicted by branch predictor 40.

FIG. 7 shows steps for allocating a new tracking entry in the NOP-compatible instruction tracking circuitry 50 (NOP tracker) for a NOP-compatible instruction starting at a branch target address of a taken backwards branch predicted by a branch predictor (such as branch predictor 40 of FIG. 4). At step 160, it is determined whether a run of one or more NOP-compatible instructions from a fetch-skip-supported subset of NOP-compatible instruction types decoded starting at a branch target address of a taken backwards branch is predicted by a branch predictor. If no, then step 160 is repeated for a subsequent run of one or more NOP-compatible instructions. If yes, then the process continues to step 162. At step 162, a new tracking entry is allocated to the NOP-compatible instruction tracking circuitry corresponding to the run of NOP(s) starting at the branch target address. With reference to FIG. 4, the decode stage 10 may in some examples allocate the new tracking entry in the NOP-compatible instruction tracking circuitry 50 having determined that a decoded run of one or more NOP-compatible instructions from a fetch-skip-supported subset of NOP-compatible instruction types starting at a branch target address of a taken backwards branch is predicted by branch predictor 40.

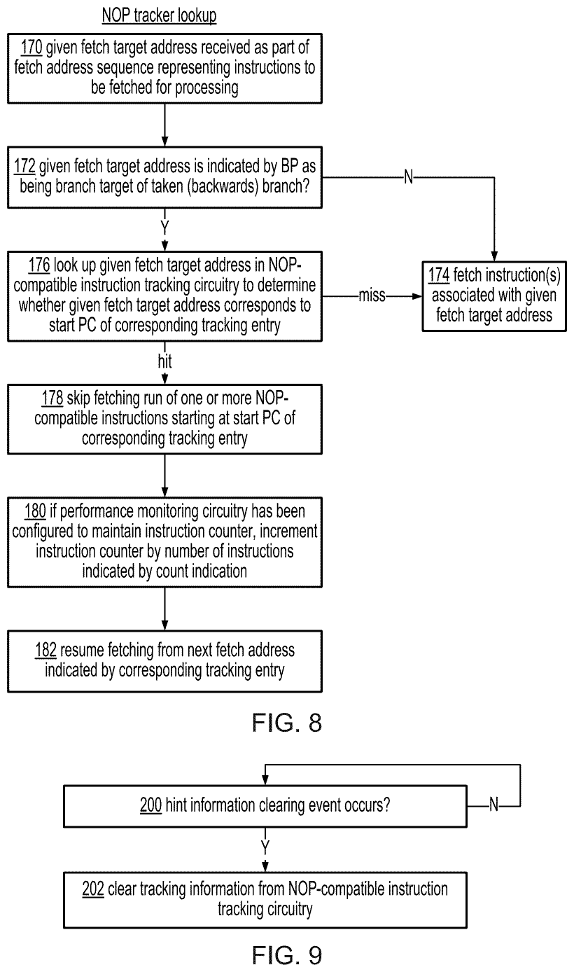

FIG. 8 illustrates steps for skipping fetching of NOP-compatible instructions that are at a branch target of a taken branch based on performing a lookup of NOP-compatible instruction tracking circuitry 50.

At step 170, a given fetch target address is received as part of a fetch address sequence representing instructions to be fetched for processing. At step 172, it is determined whether the given fetch target address is indicated by a branch predictor (such as branch predictor 40 of FIG. 4) as being a branch target of a taken branch (in some examples, a taken backwards branch). If no, the process continues to step 174 where the instruction(s) associated with the given fetch target address are fetched. If yes, the process continues to step 176. At step 176, the given fetch address is looked up in the NOP-compatible instruction tracking circuitry to determine whether the given fetch address corresponds to a start program counter of a corresponding tracking entry. If the look up misses in the NOP-compatible instruction tracking circuitry, the process returns to step 174. If the look up hits in the NOP-compatible instruction tracking circuitry, the process continues to step 178. At step 178, fetching of the run of one or more NOP-compatible instructions starting at the start program counter of the corresponding tracking entry is skipped. In implementations that comprise performance monitoring circuitry configured to maintain an instruction counter, the process continues to step 180, otherwise the process continues to step 182. At step 180, the instruction counter is incremented by the number of instructions indicated by the count indication of the corresponding tracking entry. At step 182, fetching from the next fetch address indicated by the corresponding tracking entry is resumed.

In this way, the fetching of NOP-compatible instructions located at the branch target of a taken branch (in some examples a taken backwards branch) can be efficiently skipped. As discussed herein, the present inventors have identified that runs of one or more NOP-compatible instructions may typically be located at the branch target, and particularly at the branch target of a backwards branch, and so limiting the skipping of fetching (and allocation of new entries) to runs of one or more NOP-compatible instructions occurring at branch targets can provide further energy efficiency improvements for a given level of performance uplift and reduce the size of the NOP-compatible instruction tracking circuitry.

In another example, instead of looking up the branch target in step 172 and then looking up the NOP-compatible instruction tracking circuitry in step 176, a branch target entry in a BTB may be annotated with the tracking information of the NOP-compatible instruction tracking circuitry. For example, in examples where the NOP-compatible instruction tracking circuitry is part of the BTB as described with reference to FIG. 4, a single lookup of the combined BTB/NOP-compatible instruction tracking circuitry may be performed. This reduces access resources but may require multiple iterations of the branch to become effective.

Events may occur that invalidate the tracking information. Such events may be a context switch, an interrupt or an explicit instruction for clearing hints (such as a sync barrier instruction). For example, in cases where the NOP-compatible instruction includes a hint instruction that can be treated as a NOP instruction (as it has already been executed once), this hint information is lost on a context switch and so it can be useful to clear the tracking information to allow fetching of the next occurrence of the hint instruction (i.e. so that fetching of it doesn't get skipped on next occurrence).

FIG. 9 shows steps for clearing tracking information from the NOP-compatible instruction tracking circuitry 50 in response to a hint information clearing event. At step 200, it is determined whether a hint information clearing events has occurred (such as an event described above). If no, the process returns to step 200. If yes, the process continues to step 202. At step 202, the tracking information from the NOP-compatible instruction tracking circuitry is cleared. Thus, tracking information that is no longer relevant may be cleared and the fetching of a subsequent hint instruction following a hint information clearing event is not skipped so that the hint information from the subsequent hint instruction can be processed.

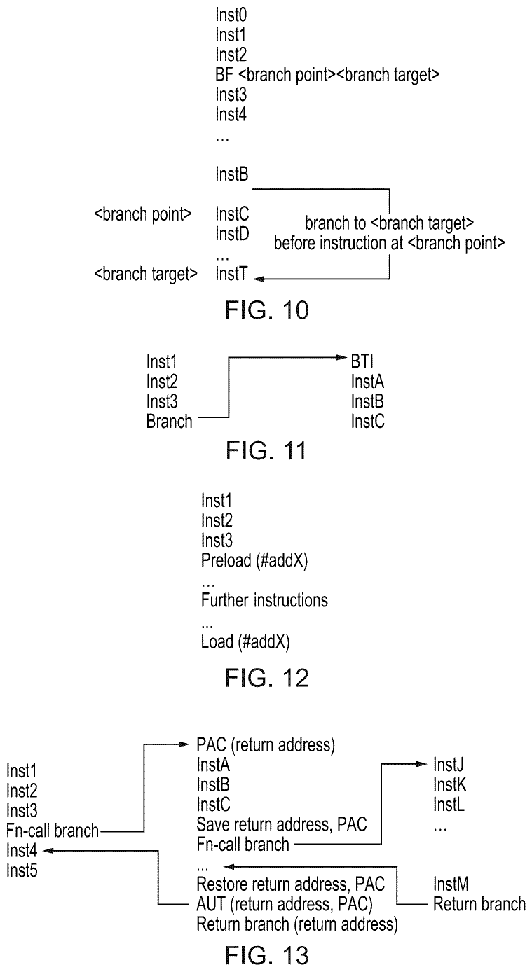

The fetch-skip-supported subset can include various instructions. These are described with reference to FIGS. 10 to 13. It will be appreciated that not all types of NOP-compatible instructions in the ISA need to be in the fetch-skip-supported subset of instruction types - e.g. some NOP-compatible instructions may be implemented on a given processor implementation and only act as NOPs on other implementations.

FIG. 10 shows a branch future (BF) instruction in program flow. A branch future instruction may be included in program flow in advance of a branch to provide the data processing apparatus with advance warning of the branch, so that the data processing apparatus can prepare to branch to the branch target in advance of the branch. In particular, because the data processing apparatus may fetch instructions associated with the branch target ahead of program flow reaching the branch point, delays to processing when the branch is then reached can be reduced or avoided. In this example, the BF instruction is inserted between Inst2 and Inst3, and provides advance warning of a branch point before InstC, where program flow is to branch to a branch target corresponding to InstT.

Some implementations may support such branch future instructions, but in implementations that do not support branch future instructions, branch future instructions are treated as NOP instructions. Hence, by skipping the fetch of BF instructions in implementations where these are treated as NOP instructions, fetch bandwidth can be improved.

FIG. 11 shows an example program flow including a branch to a branch target identification (BTI) instruction. In some implementations that enable branch target checks, certain branches may cause a fault if the instruction at the target address of a branch is not a BTI instruction. A BTI represents a legitimate or permitted branch target allowed to be a target of a taken branch instruction.

In some implementations, it may be useful to increase fetch bandwidth if the fetching of the BTI can be skipped. In some implementations, the tracking entries may also specify a no-op-compatible instruction type (for example, whether the instruction is a permitted branch target), so that the branch target check may still be performed while also skipping the fetching of the BTI. Further, in some cases, the BTI instruction is treated is a NOP. For example, in implementations that do not support branch target checks or when branch target checking is not being performed. Thus, in these cases, by skipping the fetching of the BTI instructions that would be treated as NOP instructions if processed, fetch bandwidth can be improved.

As a further example, rather than providing a branch, a low overhead loop may be used. A low overhead loop uses an instruction that hints how many iterations of the loop are likely to be needed and indicates the address of where the loop back to/jump from. However, some implementations do not support low overhead loops and so in these implementations the instructions for the low overhead loop are treated as NOP instructions. Thus, fetch bandwidth can be increased by skipping the fetching of these instructions in implementations that do not support low overhead loops.

FIG. 12 shows an example program flow including a Preload instruction. A Preload instruction provides advance warning of a future load or likely future load of data for a given address. This can allow the memory system to take actions to reduce the latency of the memory access when it later occurs. Some implementations may not support such Preload instructions and thus such implementations treat these instructions as NOP instructions. Hence, in theses implementations the fetching of the Preload instruction may be skipped to preserve fetch bandwidth.

FIG. 13 shows an example program flow including a nested function call. The nesting of function calls may require software to include instructions for saving/restoring register contents to/from a stack structure in the memory system. When information is stored in the memory system, it is more vulnerable to attack than when it is stored in registers, because depending on the system implementation an attacker may be able to gain physical access to the memory system to tamper with the stored information and/or may be able to compromise program code involving memory usage errors or other security vulnerabilities to cause data stored out in the stack structure to be overwritten incorrectly. Such attacks may risk incorrect program function and loss of data security. For example, if the return address pushed from the link register is modified while stored on the stack, then when it is later loaded back into the link register the corresponding return branch will branch to the wrong location in memory, causing execution of an incorrect instruction which could potentially be an instruction from “gadget” code provided by the attacker to cause malicious operations to be performed. This can be known as a “return oriented programming” (ROP) attack. Similar attacks may be a risk when a data address pointer is stored to the stack from a register, and is modified while stored in the memory system, so that after subsequently restoring that pointer to the registers, a load/store operation is performed to the wrong address in memory, potentially allowing access to a memory system location that should not have been accessed.

Therefore, it can be useful for the instruction set architecture to provide a countermeasure against such attacks. To this end, some processing implementations support a class of authentication code generating instructions which includes an authentication code setting instruction (e.g. a PAC instruction) and an authentication code checking instruction (e.g. an AUT instruction).

In general, the authentication code generating instruction, when decoded by instruction decoding circuitry, controls processing circuitry to generate an authentication code corresponding to an authentication target value obtained from a source register, based on a code generating function applied to the authentication target value, a cryptographic key, a first modifier value and a second modifier value. If the authentication code generating instruction is an authentication code setting instruction (PAC instruction, as shown in FIG. 13 at the start of the callee function), the generated authentication code is written to a destination register which is a general purpose register separate from the register used as the source register providing the authentication target value. If the authentication code generating instruction is an authentication code checking instruction (AUT instruction, as shown in FIG. 13 at the return branch at the end of the callee function), the generated authentication code (generated from the authentication target value obtained from a first source register) is compared with a reference authentication code obtained from a second source register which is a different general purpose register to the register providing the authentication target value, and if the generated authentication code does not match the reference authentication code, then an error response is triggered. For example, the processing circuitry 4 triggers an exception or fault condition which may cause interruption of processing and branching to an exception handler to deal with the cause of the fault.

As mentioned above, some processor implementations support such a class of authentication code generating instructions, but other processor implementations may not. For processor implementations that do not support this, the instruction for calculating or authenticating an authentication code associated with a corresponding data value (e.g. the PAC/AUT instructions) may be treated as NOP instructions. Thus, for this case, fetch bandwidth may be improved by skipping the fetching of these instructions.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

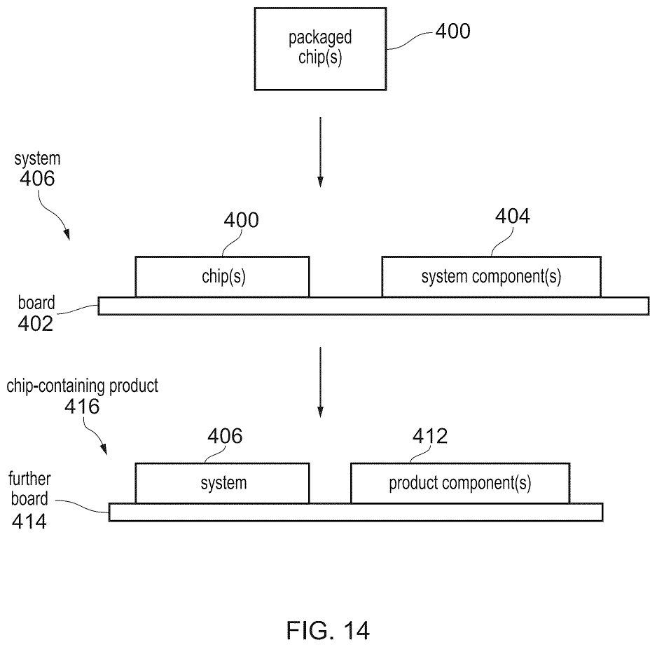

As shown in FIG. 14, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:
1. An apparatus comprising:
   no-op-compatible instruction tracking circuitry configured to store tracking information indicative of program counter addresses corresponding to no-op-compatible instructions architecturally permitted to be treated as a no-op instruction; and
   fetch skipping circuitry configured to determine, depending on whether a given fetch target address is identified as corresponding to a no-op-compatible instruction by the tracking information stored by the no-op-compatible instruction tracking circuitry, whether to skip fetching of a given instruction corresponding to the given fetch target address.
2. The apparatus according to clause 1, comprising performance monitoring circuitry configured to maintain an instruction counter indicative of a count of a number of executed instructions;
   wherein, in a case where fetching of the given instruction is skipped based on the tracking information stored by the no-op-compatible instruction tracking circuitry, the performance monitoring circuitry is configured to update the instruction counter as if the given instruction is fetched and executed, even though the given instruction is not fetched and executed.
3. The apparatus according to any of clauses 1 and 2, in which the tracking information comprises one or more tracking entries, where a given tracking entry is indicative of a start program counter address representing a start of a run of one or more no-op-compatible instructions.
4. The apparatus according to clause 3, in which the given tracking entry is indicative of a next fetch address corresponding to a next instruction occurring after the run of one or more no-op-compatible instructions.
5. The apparatus according to clause 4, in which, in response to the given fetch target address being detected as corresponding to the start program counter address of a corresponding tracking entry of the one or more tracking entries, the fetch skipping circuitry is configured to:
   skip fetching of the run of one or more no-op-compatible instructions starting from the start program counter address; and
   resume instruction fetch from the next fetch address indicated by the corresponding tracking entry.
6. The apparatus according to any of clauses 3 to 5, in which the given tracking entry specifies a count indication indicative of a number of no-op-compatible instructions in the run of one or more no-op compatible instructions.
7. The apparatus according to clause 6, comprising performance monitoring circuitry configured to maintain an instruction counter indicative of a count of a number of executed instructions; wherein
   in response to the given fetch target being detected as corresponding to the start program counter address of a corresponding tracking entry of the one or more tracking entries, the performance monitoring circuitry is configured to increment the instruction counter by the number of no-op-compatible instructions indicated by the count indication.
8. The apparatus according to any of clauses 3 to 7, in which, in response to detecting, based on instruction decoding, a run of one or more no-op-compatible instructions starting at a branch target address of a taken branch instruction, the no-op-compatible instruction tracking circuitry is configured to allocate a new tracking entry to specify, as the start program counter address, the branch target address of the taken branch instruction.
9. The apparatus according to clause 8, in which the fetch skipping circuitry is configured to trigger a lookup of the no-op-compatible instruction tracking circuitry for the given fetch target address in response to detecting that the given fetch target address corresponds to a branch target address of a taken branch, to determine whether the given fetch target address corresponds to a run of one or more no-op-compatible instructions.
10. The apparatus according to any of clauses 3 to 9, in which, in response to detecting, based on instruction decoding, a run of one or more no-op-compatible instructions starting at a branch target address of a taken backwards branch instruction, the no-op-compatible instruction tracking circuitry is configured to allocate a new tracking entry to specify, as the start program counter address, the branch target address of the taken backwards branch operation.
11. The apparatus according to clause 10, in which the fetch skipping circuitry is configured to trigger a lookup of the no-op-compatible instruction tracking circuitry for the given fetch target address in response to detecting that the given fetch target address corresponds to a branch target address of a taken backwards branch, to determine whether the given fetch target address corresponds to a run of one or more no-op-compatible instructions.
12. The apparatus according to any of clauses 3 to 11, in which the given tracking entry specifies a no-op-compatible instruction type associated with at least one of the run of one or more no-op-compatible instructions.
13. The apparatus according to any of clauses 1 to 12, comprising processing circuitry configured to execute instructions defined by an instruction set architecture, the instruction set architecture defining a plurality of no-op-compatible instruction types; and
   the no-op-compatible instruction tracking circuitry is configured to allocate the tracking information in response to detecting presence of a no-op-compatible instruction from a fetch-skip-supported subset of the plurality of no-op-compatible instruction types.
14. The apparatus according to clause 13, in which the fetch-skip-supported subset comprises at least one no-op-compatible instruction type which is unsupported by the processing circuitry.
15. The apparatus according to any of clauses 13 and 14, in which the fetch-skip-supported subset comprises at least one no-op-compatible instruction type which is supported by the processing circuitry, but which once executed a first time is redundant if executed a second time without an intervening hint information clearing event occurring between the first time and the second time.
16. The apparatus according to clause 15, in which the no-op-compatible instruction tracking circuitry is configured to clear the tracking information in response to the hint information clearing event.
17. The apparatus according to any of clauses 13 to 16, in which the fetch-skip-supported subset comprises at least one no-op-compatible instruction type which provides a performance hint that if omitted would not change architectural results of a program comprising that instruction.
18. The apparatus according to any of clauses 3 to 17, in which the fetch-skip-supported subset comprises a branch future instruction providing advance warning of a future branch operation.
19. The apparatus according to any of clauses 3 to 18, in which the fetch-skip-supported subset comprises a preload instruction providing advance warning of a future load of data for a given address.
20. The apparatus according to any of clauses 3 to 19 in which the fetch-skip-supported subset comprises an instruction for calculating or authenticating an authentication code associated with a corresponding data value.
21. The apparatus according to any of clauses 3 to 20, in which the fetch-skip-supported subset comprises a branch target instruction representing a legitimate branch target allowed to be a target of a taken branch instruction.
22. A system comprising:
   the apparatus of any of clauses 1 to 21, implemented in at least one packaged chip;
   at least one system component; and
   a board,
   wherein the at least one packaged chip and the at least one system component are assembled on the board.
23. A chip-containing product comprising the system of clause 22, wherein the system is assembled on a further board with at least one other product component.
24. A non-transitory computer-readable medium storing computer-readable code for fabrication of an apparatus comprising:
   no-op-compatible instruction tracking circuitry configured to store tracking information indicative of program counter addresses corresponding to no-op-compatible instructions architecturally permitted to be treated as a no-op instruction; and
   fetch skipping circuitry configured to determine, depending on whether a given fetch target address is identified as corresponding to a no-op-compatible instruction by the tracking information stored by the no-op-compatible instruction tracking circuitry, whether to skip fetching of a given instruction corresponding to the given fetch target address.
25. A method comprising:
   storing tracking information indicative of program counter addresses corresponding to no-op-compatible instructions architecturally permitted to be treated as a no-op instruction; and
   determining, depending on whether a given fetch target address is identified as corresponding to a no-op-compatible instruction by the tracking information stored by the no-op-compatible instruction tracking circuitry, whether to skip fetching of a given instruction corresponding to the given fetch target address.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
no-op-compatible instruction tracking circuitry configured to store tracking information indicative of program counter addresses corresponding to no-op-compatible instructions architecturally permitted to be treated as a no-op instruction; and
fetch skipping circuitry configured to determine, depending on whether a given fetch target address is identified as corresponding to a no-op-compatible instruction by the tracking information stored by the no-op-compatible instruction tracking circuitry, whether to skip fetching of a given instruction corresponding to the given fetch target address.

2. The apparatus according to claim 1, comprising performance monitoring circuitry configured to maintain an instruction counter indicative of a count of a number of executed instructions;
wherein, in a case where fetching of the given instruction is skipped based on the tracking information stored by the no-op-compatible instruction tracking circuitry, the performance monitoring circuitry is configured to update the instruction counter as if the given instruction is fetched and executed, even though the given instruction is not fetched and executed.

3. The apparatus according to claim 1, in which the tracking information comprises one or more tracking entries, where a given tracking entry is indicative of a start program counter address representing a start of a run of one or more no-op-compatible instructions.

4. The apparatus according to claim 3, in which the given tracking entry is indicative of a next fetch address corresponding to a next instruction occurring after the run of one or more no-op-compatible instructions.

5. The apparatus according to claim 4, in which, in response to the given fetch target address being detected as corresponding to the start program counter address of a corresponding tracking entry of the one or more tracking entries, the fetch skipping circuitry is configured to:
skip fetching of the run of one or more no-op-compatible instructions starting from the start program counter address; and
resume instruction fetch from the next fetch address indicated by the corresponding tracking entry.

6. The apparatus according to claim 3, in which the given tracking entry specifies a count indication indicative of a number of no-op-compatible instructions in the run of one or more no-op compatible instructions.

7. The apparatus according to claim 6, comprising performance monitoring circuitry configured to maintain an instruction counter indicative of a count of a number of executed instructions; wherein
in response to the given fetch target being detected as corresponding to the start program counter address of a corresponding tracking entry of the one or more tracking entries, the performance monitoring circuitry is configured to increment the instruction counter by the number of no-op-compatible instructions indicated by the count indication.

8. The apparatus according to claim 3, in which, in response to detecting, based on instruction decoding, a run of one or more no-op-compatible instructions starting at a branch target address of a taken branch instruction, the no-op-compatible instruction tracking circuitry is configured to allocate a new tracking entry to specify, as the start program counter address, the branch target address of the taken branch instruction.

9. The apparatus according to claim 8, in which the fetch skipping circuitry is configured to trigger a lookup of the no-op-compatible instruction tracking circuitry for the given fetch target address in response to detecting that the given fetch target address corresponds to a branch target address of a taken branch, to determine whether the given fetch target address corresponds to a run of one or more no-op-compatible instructions.

10. The apparatus according to claim 3, in which, in response to detecting, based on instruction decoding, a run of one or more no-op-compatible instructions starting at a branch target address of a taken backwards branch instruction, the no-op-compatible instruction tracking circuitry is configured to allocate a new tracking entry to specify, as the start program counter address, the branch target address of the taken backwards branch operation.

11. The apparatus according to claim 10, in which the fetch skipping circuitry is configured to trigger a lookup of the no-op-compatible instruction tracking circuitry for the given fetch target address in response to detecting that the given fetch target address corresponds to a branch target address of a taken backwards branch, to determine whether the given fetch target address corresponds to a run of one or more no-op-compatible instructions.

12. The apparatus according to claim 1, comprising processing circuitry configured to execute instructions defined by an instruction set architecture, the instruction set architecture defining a plurality of no-op-compatible instruction types; and
the no-op-compatible instruction tracking circuitry is configured to allocate the tracking information in response to detecting presence of a no-op-compatible instruction from a fetch-skip-supported subset of the plurality of no-op-compatible instruction types.

13. The apparatus according to claim 12, in which the fetch-skip-supported subset comprises at least one no-op-compatible instruction type which is unsupported by the processing circuitry.

14. The apparatus according to claim 12, in which the fetch-skip-supported subset comprises at least one no-op-compatible instruction type which is supported by the processing circuitry, but which once executed a first time is redundant if executed a second time without an intervening hint information clearing event occurring between the first time and the second time.

15. The apparatus according to claim 14, in which the no-op-compatible instruction tracking circuitry is configured to clear the tracking information in response to the hint information clearing event.

16. The apparatus according to claim 12, in which the fetch-skip-supported subset comprises one or more of:
at least one no-op-compatible instruction type which provides a performance hint that if omitted would not change architectural results of a program comprising that instruction;
a branch future instruction providing advance warning of a future branch operation;
a preload instruction providing advance warning of a future load of data for a given address;
an instruction for calculating or authenticating an authentication code associated with a corresponding data value; and
a branch target instruction representing a legitimate branch target allowed to be a target of a taken branch instruction.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A non-transitory computer-readable medium storing computer-readable code for fabrication of an apparatus comprising:
no-op-compatible instruction tracking circuitry configured to store tracking information indicative of program counter addresses corresponding to no-op-compatible instructions architecturally permitted to be treated as a no-op instruction; and
fetch skipping circuitry configured to determine, depending on whether a given fetch target address is identified as corresponding to a no-op-compatible instruction by the tracking information stored by the no-op-compatible instruction tracking circuitry, whether to skip fetching of a given instruction corresponding to the given fetch target address.

20. A method comprising:
storing tracking information indicative of program counter addresses corresponding to no-op-compatible instructions architecturally permitted to be treated as a no-op instruction; and
determining, depending on whether a given fetch target address is identified as corresponding to a no-op-compatible instruction by the tracking information stored by the no-op-compatible instruction tracking circuitry, whether to skip fetching of a given instruction corresponding to the given fetch target address.
